(19) United States
(12) Patent Application Publication
(10) Pub. No.: US 2009/0142952 A1
(43) Pub. Date: Jun. 4, 2009

(54) CONVERSION ADAPTER FOR CONNECTOR AND CONNECTOR

(76) Inventor: Junya Akasaka, Kanagawa (JP)

Correspondence Address: BARLEY SNYDER, LLC, 1000 WESTLAKES DRIVE, SUITE 275, BERWYN, PA, 19312, US

(21) Appl. No.: 11/816,993

(22) PCT Filed: Feb. 21, 2006
(86) PCT No.: PCT/JP2006/303003

§ 371 Date: Jan. 13, 2009

(30) Foreign Application Priority Data
Feb. 24, 2005 (JP) 2005-049593

(51) Int. Cl. H01R 13/213; H01R 13/62

(52) U.S. Cl. 439/314; 439/323

(57) ABSTRACT

A conversion adapter ring for a connector has a female screw, on the inner periphery of a cylindrical main body thereof for screwing and mounting onto a male screw of a screw coupling type connector. A bayonet groove is also provided on the outer periphery of the main body for engaging a bayonet coupling type connector.

An alternate connector is a connector capable of being inserted into and extracted from a mating connector in the axial direction. The connector has, in the outer periphery of a cylindrical shell that mates with the mating connector, a male screw for engaging the mating connector, and a bayonet groove formed with a notch in the male screw.

### CROSS-REFERENCE TO RELATED APPLICATION DATA

This application claims the benefit of the earlier filed parent international application number PCT/JP2006/303003 having an international filing date of Feb. 21, 2006, that claims the benefit of JP2005-049593 having a filing date of Feb. 24, 2005.

### FIELD OF THE INVENTION

The present invention relates to an electrical connector capable of being coupled/uncoupled in the axial direction and capable of both screw engagement and bayonet engagement.

### BACKGROUND

Known examples of an electrical connector capable of engaging and disengaging simply with a mating part, as in the case of an electrical connector, for example, are cited in Japanese patent publication 2003-208945A and Japanese patent publication 2004-044619A.

FIG. 4 shows an example of a plug type connector and a receptacle type connector (hereafter, also simply referred to as a “plug” and “receptacle”), having a screw engagement. After a plug 520 is mated to a receptacle 510, a rotatable ring 522 provided in the outer periphery of the mating portion of the plug 520 is rotated, and a female screw 523 formed on the inner side thereof is threaded with a male screw 512 formed on the outer periphery of a shell 511 of the receptacle 510 to fasten together the plug 520 and the receptacle 510. As a result, the receptacle 510 and the plug 520 are locked together so that they do not disengage. When uncoupling the connectors, the rotatable ring 522 is rotated in the reverse direction, the threading of the male screw 512 and the female screw 523 is released, and then the plug 520 is pulled out in the axial direction.

The receptacle 510 is configured as an electrical connector and therefore is provided with electrical contacts 518, which pass through and are supported by an insulating member 517 at the bottom of the cylindrical shell 511, and the receptacle 510 can be mounted to equipment or the like by using a base part 516. The corresponding plug 520 is also provided with electrical contacts 548 (FIG. 6) supported by an insulating member 547 on the inner side of a shell 541, and is configured so as to establish an electrical connection with the mated receptacle 510. The plug 520 is provided with a cover portion 522 at the rear of the shell 541, forming a right-angle connector whereby the cable is pulled out at a right angle to the axial direction in which the plug 520 is inserted into and extracted from the receptacle 510. A boot portion 554 supported by the cover portion 552, and having a cap ring 553 disposed therebetween, guides and protects cables pulled out from the plug 520. A graphical illustration of the cable is omitted.

FIG. 5 shows an example of a plug and receptacle configured as a bayonet coupling. After the plug 540 is mated to the receptacle 530, a rotatable ring 542 provided in the outer periphery of the mating portion is turned about a predetermined angle only, and by positioning a pair of bayonet projections 543 formed on the inner side thereof at a lock position in a bayonet groove 533 formed on the outer periphery of a shell 531 of the receptacle 530, the receptacle 530 and the plug 540 become locked so that they do not disengage. The rotatable ring 542 may be constantly pressed by a spring in the locking direction. The bayonet groove 533 is formed in a broad tapered shape with a guiding part 533a thereof at the entrance, so that the bayonet projections 543 are easily accepted. Accordingly, the bayonet projections 543 of the plug are reliably guided into a locking part 533b of the bayonet groove of the receptacle 530. When disengaging the two connectors, the rotatable ring 542 of the plug 540 is turned in the opposite direction, and the bayonet projections 543 of the plug are moved from the lock position at the locking part 533b to the guiding part 533a so that the plug can be pulled out in the axial direction. The locking structure using this bayonet coupling differs from the above-described screw-based locking structure in that when engaging or disengaging, the rotatable ring does not have to be rotated many times, and usually less than one full rotation is sufficient. Thus, the connectors can be coupled or uncoupled in a single operation.

FIG. 6 shows a cross section of a screw coupling type receptacle 510 and a mating plug 520. FIGS. 6(a) and 6(b) show coupled-state and uncoupled-state of the connectors respectively. Here, the configuration of the receptacle 510 is similar to that described above. The plug 520 is provided with a seal member 524 arranged at the surface that abuts the edge surface of the shell 511 of the receptacle 510. This type of arrangement in a screw coupling type connector enables a large engaging force to be obtained in the axial direction when the engaging screw is fastened, and as a result, the sealing member 524 is sufficiently compressed and good sealing performance can be expected.

As described above, a bayonet coupling type connector that can be attached or removed in one single movement is well suited for applications where frequent coupling and uncoupling of connectors is required. On the other hand, a screw coupling connector has the advantages of being able to engage the receptacle and plug securely, and to provide a reliable waterproofness between the two connectors. Accordingly, the two types of engagement can be used as appropriate according to the application. However, in the case where the need arises to change from screw engagement to bayonet engagement (or vice versa), because the two types are not compatible with each other, the connectors themselves must be replaced. The plug is relatively easy to replace as it is disposed to the end of the cable, but the receptacle may be difficult to replace if mounted directly on the casing of electrical equipment.

### SUMMARY

The present invention was devised in consideration of these circumstances, and it is an object of the present invention, among others, to provide a connector capable of coupling with a mating connector provided with either a screw or bayonet engagement.

The conversion adapter ring for a connector of the present invention has a female screw, on the inner periphery of a cylindrical main body thereof for screwing and mounting onto a male screw of a screw coupling type connector. A bayonet groove is also provided on the outer periphery of the main body for engaging a bayonet coupling type connector.

Moreover, a connector assembly of the present invention is a connector assembly comprising a connector capable of being inserted into and extracted from a mating connector in the axial direction. The connector having a male screw for engaging the mating connector, the male screw being disposed on the outer periphery of a cylindrical shell that mates with the mating connector A conversion adapter ring for a connector has, in the inner periphery of a cylindrical main body, a female screw for screwing and mounting onto a male screw of a screw coupling type connector, and in the outer periphery of the main body, a bayonet groove for engaging a bayonet coupling type connector. The male screw of the connector and the female screw of the conversion adapter ring for a connector thread together to form an integrated assembly.

Moreover, an alternate connector of the present invention is a connector capable of being inserted into and extracted from a mating connector in the axial direction. The connector has, in the outer periphery of a cylindrical shell that mates with the mating connector, a male screw for engaging the mating connector, and a bayonet groove formed with a notch in the male screw.

### BRIEF DESCRIPTION OF THE DRAWINGS

The invention will now be described by way of exemplary embodiments with reference the following drawings of which:

FIG. 1 is a perspective view illustrating the state for attaching a conversion adapter ring for a connector of the present invention;

FIG. 2 is a vertical cross section view of a mating receptacle and plug with a conversion adapter ring for a connector of the present invention disposed therebetween, wherein FIGS. 2(a) and 2(b) respectively show coupled-state and uncoupled-state of the connectors;

FIG. 3 is a perspective view illustrating an example of an alternate connector of the present invention;

FIG. 4 is a perspective view showing an example of a conventional screw coupling type electrical connector;

FIG. 5 is a perspective view showing an example of a conventional bayonet coupling type electrical connector; and

FIG. 6 is a vertical cross section view illustrating the waterproof structure in a conventional screw coupling type electrical connector wherein FIGS. 6(a) and 6(b) respectively show coupled-state and uncoupled-state of the connectors.

### DETAILED DESCRIPTION OF THE EMBODIMENTS

Embodiments of the present invention of an adapter ring for connector and connector will now be explained in greater detail with reference to drawings. Component parts in common with those of previously described conventional parts are assigned the same reference numerals and their descriptions are omitted as appropriate.

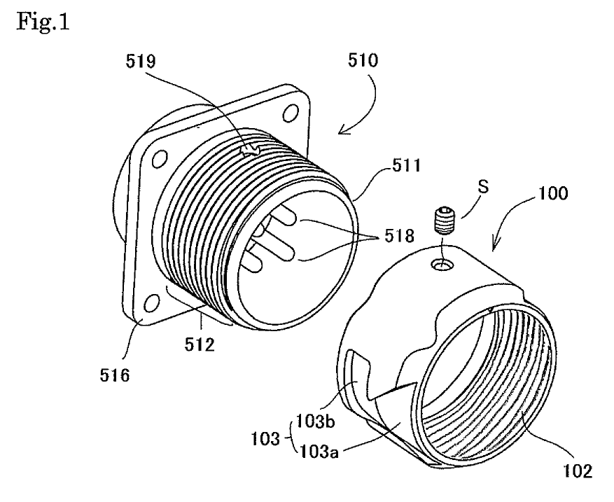

Referring to FIG. 1, the conversion adapter ring 100 has a female screw 102 formed on the inner surface of a cylindrically-shaped main body part thereof and can be screwed to mount onto the male screw 512 formed on the outer periphery of the shell 511 of the screw coupling type receptacle 510. If necessary, a retaining screw S may be used to prevent rotation of the conversion adapter ring 100. For such a case, a screw hole 519 is provided in the outer periphery of the shell 511 such that the retaining screw S can be screwed into the screw hole 519. In the outer periphery of the conversion adapter ring 100, a bayonet groove 103 for supporting a plug bayonet projection positioned in an engaged state is formed. The shape and arrangement of the bayonet groove are arbitrary as long as they are capable of holding the bayonet projection in a locked position and supporting an engaged state. The conversion adapter ring 100 is provided with a pair of bayonet grooves 103 comprised of a symmetrical arrangement of a guiding part 103a having a broad taper at the open end thereof and a locking part 103b extending from the innermost portion of the guiding part 103a outward in the circumferential direction.

This type of configuration makes it possible to use the connectors as a bayonet coupling type receptacle without replacing the screw coupling type receptacle 510. Of course, when the conversion adapter ring 100 is removed, the receptacle 510 can be used as before as a screw coupling type receptacle. The conversion adaptor ring 100 for a connector is well suited for cases in which the removal of a screw coupling type receptacle from a device and the replacement of the screw coupling type receptacle with a bayonet coupling type receptacle would be difficult.

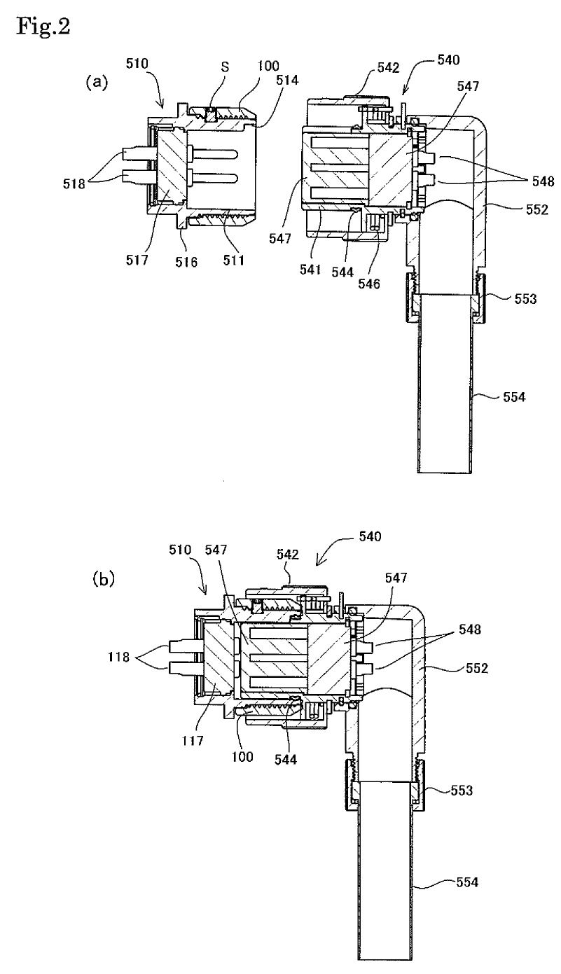

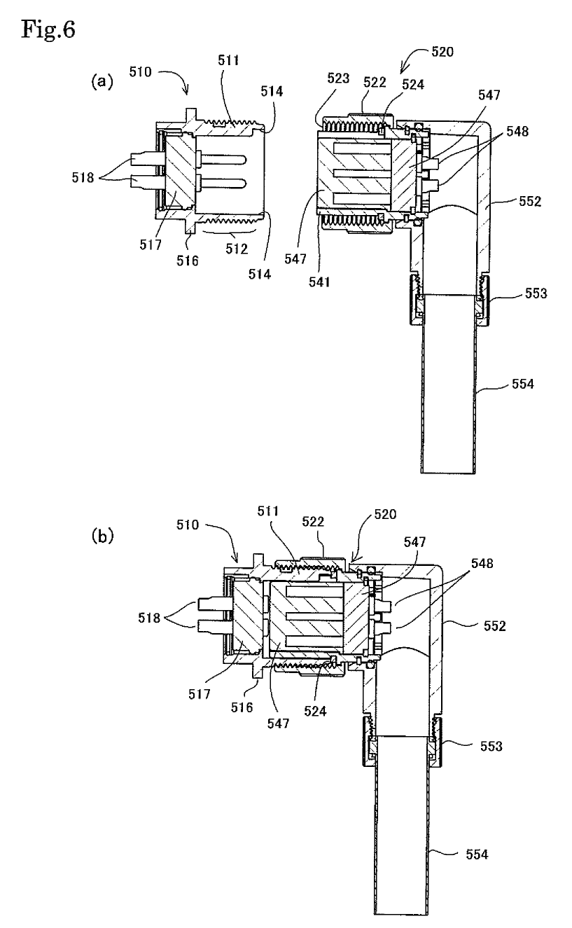

FIG. 2 shows a vertical cross section of the receptacle 510, attached with the conversion adapter ring 100, and the mating plug 540. Here, the configuration of the receptacle 510 and the plug 540 is similar to that described above. With a screw coupling type connector in which the fastening of an engaging screw enables a large engaging force to be generated in the axial direction, the seal member 524 arranged at the surface that abuts the receptacle and the plug, as shown in FIG. 6, is compressed sufficiently and good sealing performance can be expected. On the other hand, with a bayonet coupling type connector, the engaging force generated in the axial direction is not as large, and therefore good sealing performance cannot be expected even when a seal member is arranged at the surface that abuts the receptacle and the plug. Thus, on the inner side of the rotatable ring 542 of the plug 540, a seal member 544 for waterproofing is arranged in the outer periphery of the shell 541 that is inserted into the shell 511 of the receptacle 510. Then, when the plug 540 is mated, the seal member 544 pressed by the inner periphery of the shell 511 of the receptacle 510 and compressed in the radial direction, exhibits sealing performance. The rotatable ring 542 of the plug 540 is constantly pressed in the locking direction by a spring 546.

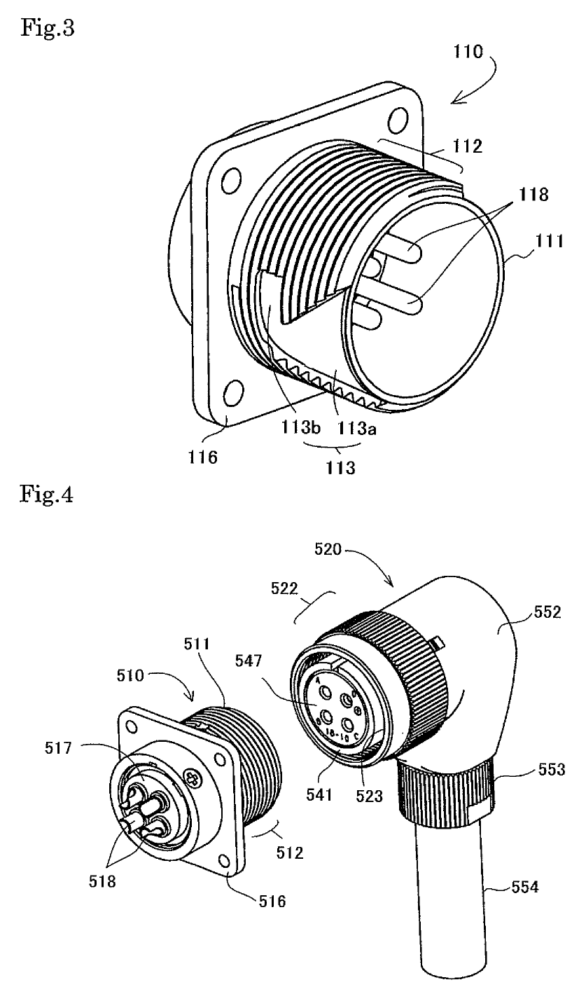

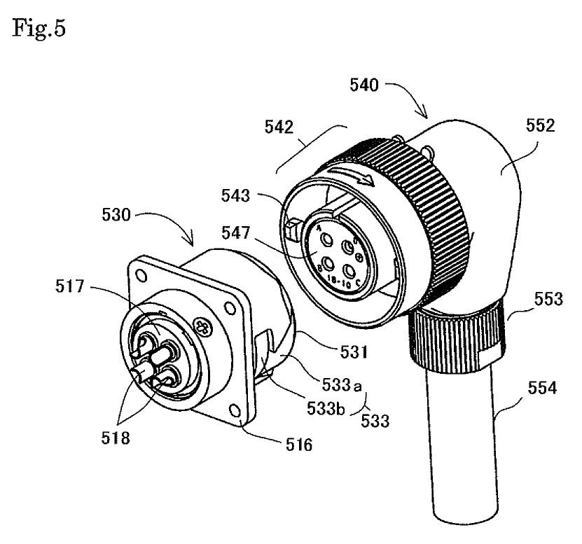

Next, an alternate connector of the present invention is explained with reference to FIG. 3 The electrical connector 110 is a receptacle, and is provided with a cylindrical shell 111 formed with both a male screw 112 for engaging a plug connector (not shown) and a bayonet groove 113 on the outer periphery thereof, a base part 116 for mounting the connectors on a electrical equipment or the like, and electrical contacts 118 passing through and supported by an insulating member (not shown) at the bottom of the shell 111. The bayonet groove 113 is formed with a notch in the male screw 112 so as not to interfere with threading of the engaging screws, and is comprised of a guiding part 113a having a broad taper at the open end thereof and a locking part 113b extending from the innermost portion of the guiding part 113a outward in the circumferential direction.

With this type of configuration, in the case where the mating plug-side connector is provided with a screw type engaging means, the electrical connector 110 is able to engage with the male screw 112, and in the case where the mating plug-side connector is provided with a bayonet type engaging means, the electrical connector 110 is able to engage with the bayonet groove 113. The electrical connector 110 is configured from fewer components than a connector assembly in which the adapter 100 is attached on a screw coupling type receptacle, and has high mechanical strength since the bayonet groove is formed integrally with the shell. The electrical connector 110 also enables the use of a bayonet type coupling connector, and is well suited for application in cases where the screw coupling type receptacle can be removed and replaced.

The above explanation used an example of a case in which the connector of the present invention is an electrical connector, but embodiments of the present invention are not limited to that example. Needless to say, connectors used in various types of applications, such as a fluid connector, for example, may also be applied.

1. A conversion adapter ring for a connector comprising:
a female screw, on the inner periphery of a cylindrical main body thereof, for screwing and mounting onto a male screw of a screw coupling connector; and
a bayonet groove, on the outer periphery of the main body, for engaging a bayonet coupling connector.

2. A connector assembly comprising:
a connector capable of being inserted into and extracted from a mating connector in the axial direction, having a male screw for engaging the mating connector, the male screw being disposed on the outer periphery of a cylindrical shell that mates with the mating connector; and
a conversion adapter ring for a connector, the conversion adapter ring having, in the inner periphery of a cylindrical main body, a female screw for threading and mounting to a m the connector, and in the outer periphery of the main body, a bayonet groove for engaging a bayonet coupling connector; wherein
the male screw of the connector and the female screw of the conversion adapter ring for a connector thread together to form an integrated assembly.

3. A connector capable of being inserted into and extracted from a mating connector in the axial direction; the connector having, in the outer periphery of a cylindrical shell that mates with the mating connector, a male screw for engaging the mating connector, and a bayonet groove formed with a notch in the male screw.

4. The conversion adaptor ring of claim 1 further comprising a retaining screw located in the ring, the screw being engageable with the screw coupling connector.

5. The conversion adaptor ring of claim 1 wherein the bayonet groove further comprises a guiding part having a broad taper at the open end thereof.

6. The conversion adaptor ring of claim 5 wherein the bayonet groove further comprises a locking part extending from the innermost portion of the guiding part outward in a circumferential direction.

7. The connector assembly of claim 2 further comprising a retaining screw located in the ring, the screw being engageable with the connector.

8. The connector assembly of claim 2 wherein the bayonet groove further comprises a guiding part having a broad taper at the open end thereof.

9. The connector assembly of claim 8 wherein the bayonet groove further comprises a locking part extending from the innermost portion of the guiding part outward in a circumferential direction.

10. The connector of claim 3 wherein the bayonet groove further comprises a guiding part having a broad taper at the open end thereof.

11. The connector of claim 10 wherein the bayonet groove further comprises a locking part extending from the innermost portion of the guiding part outward in a circumferential direction.
